(19) United States
(12) Patent Application Publication
(10) Pub. No.: US 2021/0284093 A1
(43) Pub. Date: Sep. 16, 2021

(54) FRONT STRUCTURE OF VEHICLE CABIN

(71) Applicants: TOYOTA JIDOSHA KABUSHIKI KAISHA, Aichi (JP); SUBARU CORPORATION, Tokyo (JP)

(72) Inventors: Yoko TANAKA, Toyota-shi (JP); Masashi KAWAMOTO, Okazaki-shi (JP); Naoki SAWADA, Toyota-shi (JP)

(21) Appl. No.: 17/176,183

(22) Filed: Feb. 16, 2021

(30) Foreign Application Priority Data
Mar. 10, 2020 (JP) 2020-041291

(51) Int. Cl. B60R 21/206; B62D 25/14

(52) U.S. Cl. CPC B60R 21/206; B62D 25/145

(57) ABSTRACT

A front structure of a vehicle cabin may include: an instrument panel arranged in front of a passenger seat; a crossbeam arranged in the instrument panel and connected to right and left sides of a vehicle body; and an airbag bracket fixed to the crossbeam inside the instrument panel and supporting an airbag for the passenger seat. The airbag bracket may extend rearward beyond the airbag and incline upward.

### CROSS-REFERENCE TO RELATED APPLICATION

This application claims priority to Japanese Patent Application No. 2020-041291 filed on Mar. 10, 2020, the contents of which are hereby incorporated by reference into the present application.

### TECHNICAL FIELD

The art disclosed herein relates to a front structure of a vehicle cabin of a vehicle. It especially relates to art to realize a space-efficient structure for protecting knees of a passenger in a passenger seat upon a collision to the vehicle.

### BACKGROUND

Japanese Patent Application Publications Nos. 2016-188025 and 2019-167043 each describe a structure for protecting knees of a passenger in a passenger seat upon a collision. The structures described in those documents are as follows. A crossbeam extending in a vehicle width direction is arranged inside an instrument panel of a vehicle. A knee protector is fixed to the crossbeam in front of a passenger seat of the vehicle. A front end of the knee protector is fixed to the crossbeam and a rear end thereof is located in front of the knees of the passenger. The crossbeam connected to left and right sides of a vehicle body inside the instrument panel may be called an instrument panel member or an instrument panel reinforcement. It should be noted that “instrument panel” herein is an interior part located at a front portion of a vehicle cabin and is a housing that houses various meters, audio devices, switches, and airbags.

### SUMMARY

An airbag is also arranged inside an instrument panel in front of a passenger seat. The disclosure herein provides art for space-efficiently arranging an airbag and a protector configured to protect knees of a passenger upon a collision inside an instrument panel in front of a passenger seat.

A front structure of a vehicle cabin disclosed herein may comprise: an instrument panel arranged in front of a passenger seat; a crossbeam arranged in the instrument panel and connected to right and left sides of a vehicle body; and an airbag bracket fixed to the crossbeam inside the instrument panel and supporting an airbag for the passenger seat. The airbag bracket may extend rearward beyond the airbag and incline upward.

In the front structure disclosed herein, a rear portion of the airbag bracket supporting the airbag serves as a knee protector. The art disclosed herein enables the airbag and the knee protector (airbag bracket) to be arranged in a small space.

The front structure disclosed herein may further comprise an air duct arranged under the airbag bracket and extending along a vehicle width direction. The air duct is softer than metal, thus the air duct contributes to knee protection upon a collision.

Details and further improvements of the technique disclosed herein will be described in Detailed Description below.

### BRIEF DESCRIPTION OF DRAWINGS

FIG. 1 shows a front view of an instrument panel.

FIG. 2 is a cross-sectional view along a line II-II of FIG. 1.

FIG. 3 is an enlarged cross-sectional view around an airbag shown in FIG. 2.

FIG. 4 is a perspective view around the airbag for a passenger seat.

### DETAILED DESCRIPTION

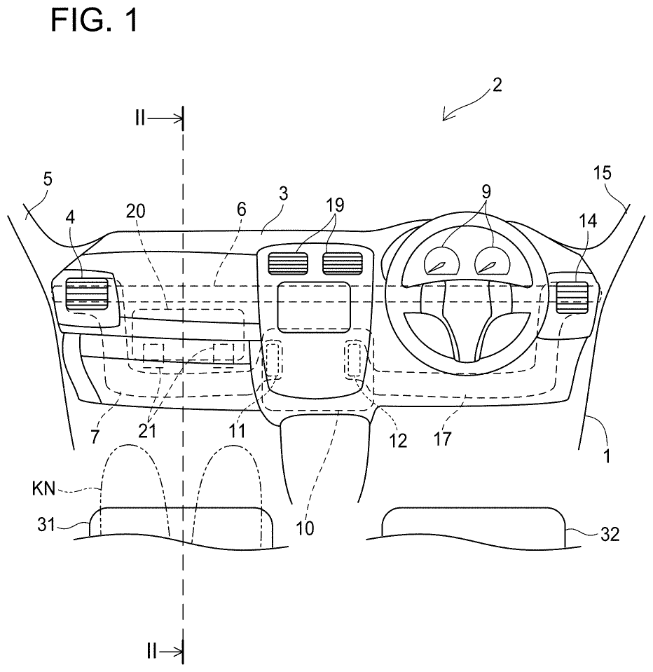

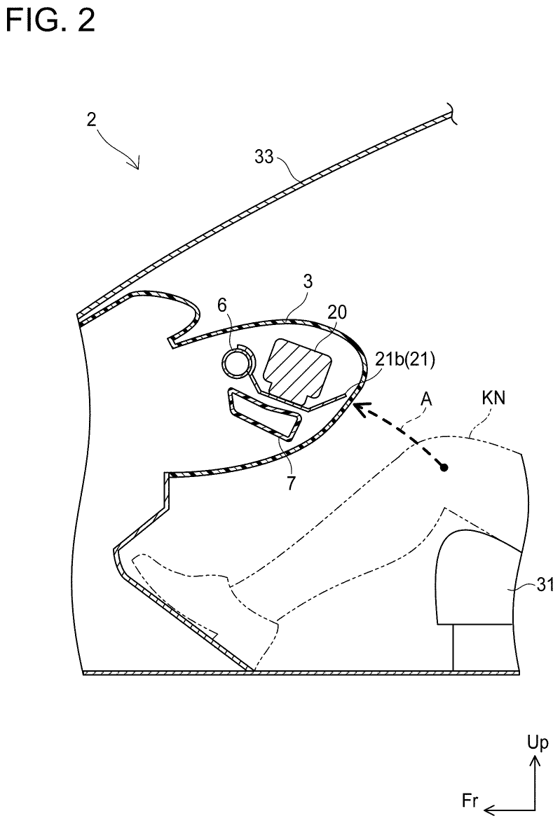

A vehicle cabin front structure 2 according to an embodiment will be described with reference to the drawings. FIG. 1 shows a front view of an instrument panel 3 and FIG. 2 shows a cross-sectional view along a line II-II of FIG. 1. The cross section of FIG. 2 is obtained by cutting the instrument panel 3 in front of a passenger seat 31 along a plane perpendicularly intersecting a vehicle width direction. In FIGS. 1 and 2, knees KN of a passenger seated in the passenger seat 31 are depicted by phantom lines. In the coordinate system of FIG. 2, “Fr” refers to a front direction of the vehicle, and “Up” refers to an up direction of the vehicle.

In narrow terms, an instrument panel refers to meters 9 on a driver seat 32 side, however, the instrument panel 3 herein refers to a part that extends in front of the driver seat 32 and the passenger seat 31 from one end to another end of a vehicle body 1 in the vehicle width direction.

The instrument panel 3 is an interior part located at a front portion of the vehicle cabin and is a housing that houses various meters, audio devices, switches, airbags, and the like. The instrument panel may be called a dashboard. The instrument panel 3 is constituted of resin. A windshield 33 is located above the instrument panel 3 (see FIG. 2).

An air conditioner main body 10 is arranged inside the instrument panel 3 at approximately the center of the vehicle body 1 in the vehicle width direction. Air from the air conditioner main body 10 is blown out from air outlets 4, 14, 19 provided at the instrument panel 3. The air outlet 19 that is provided at the center of the instrument panel 3 in the vehicle width direction may be called a center register. The air outlets 4, 14 that are respectively provided at ends of the instrument panel 3 in the vehicle width direction may be called side registers. The air conditioner main body 10 includes air discharge ports 11, 12. The air discharge port 11 is connected to the air outlet 4 on passenger seat 31 side via an air duct 7. The air discharge port 12 is connected to the air outlet 14 on the driver seat 32 side via an air duct 17. Details of the air duct 17 on the driver seat 32 side will be omitted.

The air outlet 19 located at the center in the vehicle width direction is also connected to the air conditioner main body 10 via another air duct, but this air duct is not shown.

In FIG. 1, the air conditioner main body 10, the air ducts 7, 17, a crossbeam 6 (to be described later), an air bag 20 (to be described later), and air bag brackets 21 (to be described later) arranged inside the instrument panel 3 are depicted by dashed lines.

The crossbeam 6 is arranged inside the instrument panel 3. The crossbeam 6 is connected to a right side and a left side of the vehicle body 1. More specifically, the crossbeam 6 is connected to a left front pillar 5 and a right front pillar 15. The front pillars 5, 15 are parts of a frame that ensures strength required for the vehicle body 1, and the crossbeam 6 is also a part of the frame. The crossbeam 6 arranged inside the instrument panel 3 may be called an instrument panel reinforcement.

The air bag 20 for the passenger seat is arranged inside the instrument panel 3 in front of the passenger seat 31. The “air bag 20” herein means an assembly including an air bag main body, a case, and an inflator. The air bag 20 for the passenger seat is supported by the crossbeam 6 via a pair of metal brackets (air bag brackets 21) (see FIG. 2). An air bag in front of the driver seat 32 is not shown.

As shown in FIG. 1, each of the pair of airbag brackets 21 is located substantially in front of its corresponding one of the pair of knees KN.

As described above, the air duct 7, which connects the air conditioner main body 10 to the air outlet 4 on the passenger seat 31 side, is arranged inside the instrument panel 3. The air duct 7 extends in front of the passenger seat 31 at a position lower than the crossbeam 6. Further, the air duct 7 extends at a position lower than the air bag 20 and the air bag brackets 21.

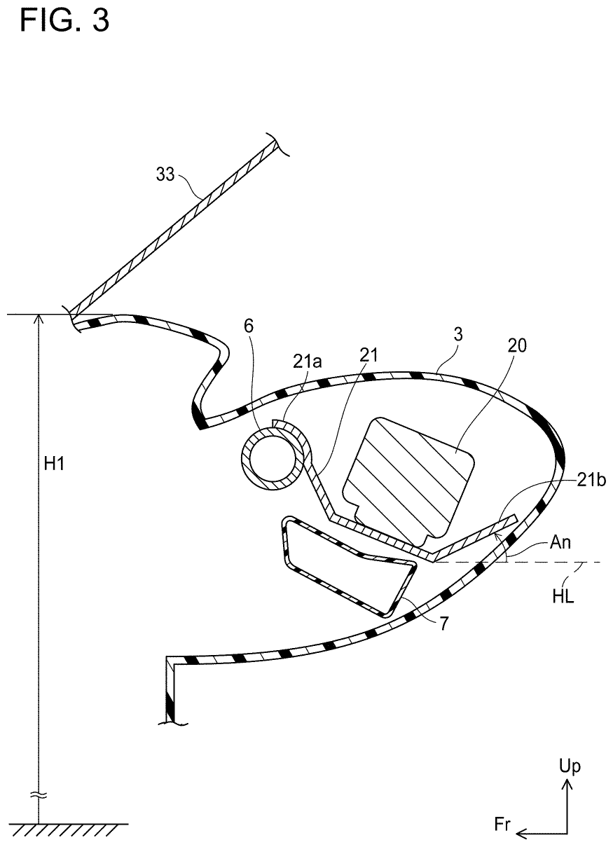

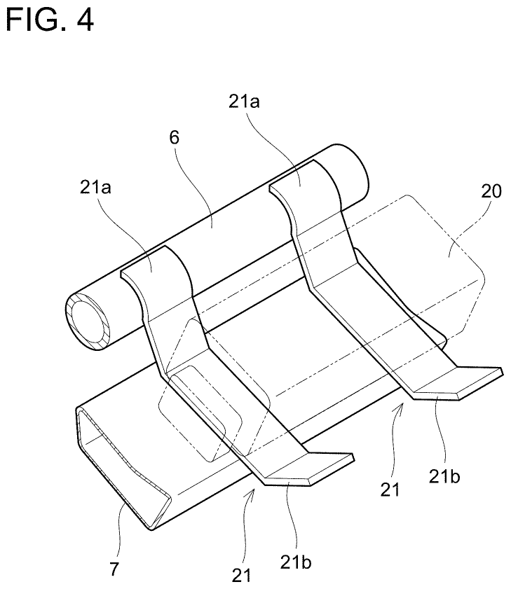

FIG. 3 is an enlarged view around the airbag 20 shown in FIG. 2. FIG. 4 is a perspective view around the airbag 20. In FIG. 4, the airbag 20 is depicted by a phantom line to clearly show the airbag brackets 21. As shown in FIGS. 3 and 4, the airbag brackets 21 are arranged to align along the vehicle width direction and support the airbag 20 from below.

Each of the airbag brackets 21 is formed of a narrow metal plate, and its longitudinal direction is along a vehicle front-rear direction. In a side view of the vehicle, each of the airbag brackets 21 curves with its center portion protruding downward. Front ends 21a of the airbag brackets 21 are fixed to the crossbeam 6. Rear portions 21b of the airbag brackets 21 extend rearward beyond the airbag 20. The rear portions 21b are inclined upward. In other words, each rear portion 21b is inclined with its front side positioned lower than its rear side. A broken line HL in FIG. 3 indicates a horizontal line. An inclination angle An of the rear portions 21b of the airbag brackets 21 with respect to the horizontal line HL is in a range of about 5 to 60 degrees.

A broken line A in FIG. 2 indicates how the knees KN of the passenger move when the vehicle collides with an obstacle. The knees KN hit the instrument panel 3. The rear portions 21b of the airbag brackets 21 are located inside the instrument panel 3 to be opposed to the knees KN. As described, the rear portions 21b are inclined with their front sides positioned lower than their rear sides. Wide surfaces of the rear portions 21b of the airbag brackets 21 formed of metal plates are opposed to the knees KN. The instrument panel 3 is pushed forward by the knees KN upon a collision, however, the instrument panel 3 is supported by the rear portions 21b of the airbag brackets 21. The airbag brackets 21 protect the knees of the passenger in the passenger seat 31 upon a collision to the vehicle.

Since the instrument panel 3 is arranged between the airbag brackets 21 and the knees KN, the airbag brackets 21 may not be arranged exactly in front of the knees KN. Even if the airbag brackets 21 are offset to the knees KN to some extent in the vehicle width direction, the airbag brackets 21 protect the knees KN via the instrument panel 3.

The air duct 7 is arranged inside the instrument panel 3. The air duct 7 is arranged in front of the passenger seat 31. The air duct 7 extends in the vehicle width direction under the airbag brackets 21. The air duct 7 is constituted of resin that is softer than metal. The air duct 7 also contributes to the protection of the knees KN of the passenger in the passenger seat 31 upon a collision to the vehicle.

In the vehicle cabin front structure 2 according to the present embodiment, the airbag brackets 21 supporting the seat airbag 20 for the passenger seat protect the knees KN of the passenger in the passenger seat upon a collision. The airbag brackets 21 supporting the airbag 20 serve as a knee protector. The vehicle cabin front structure 2 of the present embodiment enables the airbag 20 and the knee protector (airbag brackets 21) to be arranged in a small space.

Especially, the airbag 20 and the knee protector (airbag brackets 21) are housed in a space at a low height. This enables a height of the instrument panel 3 to be low. Further, arranging the air duct 7 to extend in front of the passenger seat 31 at a low position (that is, under the airbag brackets 21) contributes to lowering the height of the instrument panel 3.

A height H1 in FIG. 3 indicates a height of an upper surface of the instrument panel 3 from a ground surface. The airbag brackets 21 also serve as the knee protector. The air duct 7 extends not above but below the crossbeam 6. These two points enable the height H1 of the upper surface of the instrument panel 3 to be low. Lowering the height H1 of the upper surface of the instrument panel 3 improves front visibility for a driver.

Other advantages of arranging the air duct 7 to extend at the lower position in front of the passenger seat 31 will be described. The upper surface of the instrument panel 3 is heated by sunlight passing through the windshield 33. If the air duct 7 extends proximate to the upper surface of the instrument panel 3, cool air from the air conditioner main body 10 is heated in summer Allowing the air duct 7 to extend below the crossbeam 6 increases a distance between the air duct 7 and the upper surface of the instrument panel 3. This structure can reduce an influence of the heat of the upper surface of the instrument panel 3 on the air in the air duct 7.

Especially by allowing the air duct 7 to extend at the position lower than the air bag 20 and the air bag brackets 21, the influence of the heat of the upper surface of the instrument panel 3 on the air in the air duct 7 can be efficiently reduced.

Points to be noted relating to the art described in the embodiment will be listed. Within the instrument panel 3, various devices are arranged other than the crossbeam 6, the air conditioner main body 10, the air ducts 7, 17, and the air bag 20, however, these devices are not shown in the drawings.

A mount stay may extend from an upper surface(s) of at least one of the airbag brackets 21, and the airbag 20 may be supported by the mount stay(s).

A portion of the instrument panel 3 located rearward of the pair of airbag brackets 21 corresponds to “a knee protector plate extending between the rear portions 21b of the airbag brackets 21”, however, an auxiliary knee protector plate may additionally extend between the rear portions 21b.

The While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A front structure of a vehicle cabin, the front structure comprising:
an instrument panel arranged in front of a passenger seat;
a crossbeam arranged in the instrument panel and connected to right and left sides of a vehicle body; and
an airbag bracket fixed to the crossbeam inside the instrument panel and supporting an airbag for the passenger seat,
wherein
the airbag bracket extends rearward beyond the airbag and inclines upward.

2. The front structure of claim 1, further comprising an air duct arranged under the airbag bracket and extending along a vehicle width direction.
